(19) United States
(12) Patent Application Publication
(10) Pub. No.: US 2011/0046303 A1
(43) Pub. Date: Feb. 24, 2011

(54) POLYAMIDE WITH REDUCED CRYSTALLINITY

(76) Inventors: Jules Harings, Eindhoven (NL); Yogesh Sheshrao Deshmukh, Eindhoven (NL); Esther Vinken, Eindhoven (NL); Sanjay Rastogi, Leicestershire (GB)

Correspondence Address: NIXON & VANDERHYE, PC, 901 NORTH GLEBE ROAD, 11TH FLOOR, ARLINGTON, VA, 22203, US

(21) Appl. No.: 12/922,330

(22) PCT Filed: Mar. 13, 2009
(86) PCT No.: PCT/EP09/53020

§ 371 Date: Oct. 14, 2010

(30) Foreign Application Priority Data
Mar. 13, 2008 (EP) 08152691.5

(51) Int. Cl. C08L 77/00

(52) U.S. Cl. 524/608

(57) ABSTRACT

The invention relates to a novel process for making compositions comprising a polyamid, water and a salt, having reduced crystallinity, wherein the process comprising the steps of: a. mixing the polyamide, water and a salt b. heating the mixture to a temperature above 100° C. in a range between 120° C. below the Brill temperature and 50° C. above the Brill temperature of the polyamide at a pressure above the vapour pressure of the mixture at said temperature c. optionally cooling down the mixture.

The invention relates to a polyamide with reduced crystallinity, a process for obtaining a polyamide, wherein the crystallinity and/or the formation of crystallinity of the polyamide can be controlled or modified and the use of the polyamide in for example fabrication of fibers.

Polyamides with reduced crystallinity are known in the art. U.S. Pat. No. 3,591,565 describes polyamides containing alkali metal halide additives as void formation inhibitors. Polyhexamethylene adipamide resin pellets are coated with a binder composition and lithium chloride or lithium bromide, wherein the salts have been dried before use. The salt can also be added to the mixture of adipic acid and hexamethylenediamine before the formation of the polymer. After coating or polymerization, a polyamide is obtained containing a salt, which is extruded into a fiber and subsequently drawn to 4-6 times their undrawn length.

U.S. Pat. No. 4,167,614 describes non-aromatic polyamides containing inorganic salts of the class of the halides of alkaline or alkaline-earth metals, and a process of multidirectionally orienting the obtained material at a prevalently amorphous state and developing of the crystallinity by a prolonged heating of the polyamide, while maintaining the material under the acquired draft and tension conditions. Examples are present with nylon 6 and LiCl, LiBr and CaCl₂ as salts. Mixtures are prepared by heating the pure nylon 6 with the salts in the melt of the polymer.

Anciero et al. (Journal of Polymer Science: Polymer Physics, vol 17, 1903-1912 (1979) describes that the addition of LiCl to nylon 6 causes a large depression of the melting temperature and of the crystallization rate of the pure polyamide. Vasanthan et al. (Polymer 45 (2004) 4077-4085), shows a similar effect for the presence of GaCl₃ as a salt in polyamide 66. The GaCl₃ has however the disadvantage that removal from the polymer turned out to be difficult, and relaxation of polymer upon orientation occurs, thereby losing the orientation and fiber properties of the drawn polyamide.

JP1132822 and JP3009931 (Asahi Chemical) disclose the gel spinning of a polyamide containing a solvent and a salt, wherein the solvent is an organic solvent, that needs to be recovered after the gel spinning process.

Rastogi et al. (Macromolecules 2004, 37, 8825-8828) disclose the dissolution of Nylon-4,6 in water, by heating the nylon in water at temperatures above 200° C.

Wevers et al. (Lecture Notes in Physics, 714, 153-168) describe the full dissolution of polyamide 6 in water and polyamide 4.6 in water and ethanol.

Valenti et al. (The Journal of Physical Chemistry, 77, 3, 389-395) describe mixtures of nylon 6 and one of the salts LiBr, LiCl and KCl, prepared by melting, under vacuum at 260° C.

The processes known in the literature have the disadvantage that meltprocessing is needed to obtain a mixture of polyamide and salt, which has disadvantages of for example degradation of polyamide or colouring of the polymer, or an organic solvent is used that needs to be recovered from the fibers after fiber formation.

There is a need for a simple and versatile process for obtaining a polyamide, wherein the crystallinity and/or the formation of crystallinity of the polyamide can be controlled or modified.

The present invention discloses a process for making a mixture comprising a polyamide, water and a salt, comprising the steps of

a. mixing a polyamide, water and a salt;

b. heating the mixture to a temperature above 100° C. in a range between 120° C. below the Brill temperature and 50° C. above the Brill temperature of the polyamide at a pressure above the vapour pressure of the mixture at said temperature; and

c. optionally cooling down the mixture.

The polyamides used in the process according to the present invention, preferably have a melting point between −50° C. and 150° C. Preferably the salt used in the process according to the present invention is an inorganic salt. In the context of the present invention, the solvent (i.e. solvent for polyamide) essentially consists of water and salt. It may, however also comprise an organic solvent (e.g. an alcohol) in an amount smaller than 10 wt %.

The process of the invention may be followed by other steps like for example cooling down the mixture (e.g. to room temperature), applying shear to the solution, rinsing the solution with water and the like. The order of mixing the components in step a is not critical. In step a the components can be mixed in different ways, like for example mixing all components at once; or for example first mixing water and salt to obtain a solution, which is subsequently mixed with the polyamide; or in other ways.

The mixture comprising polyamide, water and salt may contain other components like for example stabilizers, antioxidants, processing compounds, fillers, colouring agents and additives.

It may sometimes be difficult to determine the Brill transition temperature, or for some polyamides the Brill transition temperature may not exist. In that case, the mixture comprising polyamide, water and salt is heated to a temperature above 100° C. and between 150 and 10° C. below the melting temperature of the polyamide, or preferably between 140 and 30° C., more preferably between 130 and 50° C. below the melting temperature of the polyamide at a pressure above the vapour pressure of the mixture at said temperature.

In case a polyamide does not have a melting temperature, the mixture comprising polyamide, water and salt is heated to a temperature above 100° C. and between 150 and 10° C. below the degradation temperature of the polyamide, or preferably between 140 and 30° C., more preferably between 130 and 50° C. below the degradation temperature of the polyamide at a pressure above the vapour pressure of the mixture at said temperature.

In a preferred embodiment the mixture used in process step b of the process of the present invention (i.e. the mixture comprising a polyamide, water and a salt) is heated under pressure to a temperature above 100° C.

### PREFERRED EMBODIMENTS AND ADVANTAGES

A polyamide is a polymer containing amide moieties. These amide moieties are generally formed from the reaction of a carboxylic acid or acyl halides and an amine. The reaction is a polycondensation reaction, whereby water is formed as the reaction product, which needs to be removed from the mixture to obtain a high degree of polymerization.

Formation of polyamides is known in the art. The properties of the polyamides depend on the block lengths between the amide groups. Since the properties are also dependent on the amount of water in the polyamides, which absorb a significant amount of water due to the hydrophilic amide moieties, the comparison of the mechanical properties in Table 1 (below) is based on dry samples (containing less than 1 wt % of water).

Examples of polyamides are the common polyamides listed in Table 1, like polyamide 6, polyamide 11, polyamide 12, polyamide 4,6, polyamide 6,6, polyamide 6,9, polyamide 6,10, polyamide 6,12, but the potential combinations may extend beyond the 8 listed samples. Copolymers of polyamides with other monomers or block-copolymers of polyamides can also be mentioned as examples of polyamides that can be used in the process of the present invention.

TABLE 1
Properties of common polyamides

| | Tensile | | Flexural | Impact | Impact |
|---|---|---|---|---|---|
| | strength | Elongation | Modulus | strength | strength |
| Polyamide | MPa | % | MPa | ft.lb/inc | J/m |
| 6 | 81 | 50-150 | 2800 | 1.0-1.2 | 53-64 |
| 11 | 55 | 200 | 1200 | 0.7-1.3 | 37-69 |
| 12 | 55 | 200 | 1100 | 1.8 | 96 |
| 4, 6 | 99 | 40 | 3100 | 2.0 | 107 |
| 6, 6 | 83 | 40-80 | 2800 | 1.0-1.2 | 53-64 |
| 6, 9 | 55 | 125 | 2000 | 1.1 | 59 |
| 6,10 | 59 | 130 | 2000 | 1.1 | 59 |
| 6,12 | 55 | 150 | 2000 | 1.1 | 59 |

The viscosity average molecular weight of the polyamides used in the present invention preferably ranges between 10⁴ to about 10⁹ g/mol, more preferably between 10⁵ and 10⁷. The viscosity average molecular weight of the polyamide is calculated from the Mark-Houwink equation:

[η]=KMW^{a}

Wherein: [η] is the intrinsic viscosity; MW is the viscosity averaged molecular weight; and K and a are constants which can be found in literature, like for example the Polymer Data Handbook, edited by James E. Mark, published by Oxford University Books (1999), (http://www.qmc.ufsc.br/˜minatti/docs/20061/polymer data handbook.pdf).

For example for the system nylon 6,6/formic acid at 25° C. the value for K is 35.3 ml/g and the value for a=0.786.

The intrinsic viscosity can be determined from the following equation,

$$[ η ] = \frac{2}{C} ( {η}_{rel}^{1 / 2} - 1 )$$

Wherein: [η] is the intrinsic viscosity; C is the polymer concentration; and ηᵣₑₗ is the relative viscosity of the polymer solution (i.e. the viscosity of the polymer relative to the viscosity of the pure solvent)

The relative viscosity, ηᵣₑₗ, may be determined by viscometric measurements using an Ubbelohde viscometer (Test Methods: ISO 3104, ISO 3105, ASTM D 445, ASTM D 446, IP 71, BS 188). The viscosimetric measurements are generally conducted at 25° C., and formic acid is used as a solvent. The relative viscosity may be calculated using the following equation:

$${η}_{r} = \frac{η}{{η}_{0}} = \frac{t ρ}{{t}_{0} {ρ}_{0}} .$$

Wherein: ηᵣ=ηᵣₑₗ; η is the viscosity of the polymer solution; η₀=the viscosity of the pure solvent, t is the characteristic flow time of the polymer solution measured with the Ubbelohde viscosimeter, t₀ is the characteristic flow time of the pure solvent measured with the Ubbelohde viscosimeter; ρ is the mass density of the polymer solution; and ρ₀ is the mass density of the polymer solution.

The process of the present invention applies the polyamide preferably in an amount between 1 and 95 weight percent (relative to the total of the composition), more preferably between 2 and 80 wt %, or even more preferably between 5 and 60 wt %.

In the process of the invention the polyamide is preferably dissolved in water containing a salt under superheated conditions, this means at a temperature above 100° C. and under pressure. Preferably, the mixture is heated above 110° C., or 120° C., under pressure (above the vapour pressure of the mixture at said temperature) such that the mixture does not boil. Under these conditions the hydrogen bonding efficiency between water molecules is believed to be reduced, which may facilitate the dissolution of the polyamide.

The temperature of the process of the invention is important for an intimate mixing of the salt with the polyamide and an effective dissolution of the polyamide. It has been surprisingly found, that dissolution of the polyamide occurs at relatively low temperatures when a solution of a salt is used, compared to methods known in literature.

It has been found that the optimum dissolution temperature depends on the polyamide used. The optimum temperature ranges around the so-called Brill temperature, which has been measured under ideal conditions for a number of polyamides (see Macromolecules 2000, 33, 2642-2650, and Table 2). The Brill transition temperature (Tb) is defined as the temperature at which the interchain (100) and the intersheet (010/110) reflections merge in X-ray scattering on heating a sample (see experimental part). It is known that the Brill temperature may be dependent on the crystallisation conditions of the polyamide in question (see Macromolecules 2000, 33, 2642-2650). Therefore a range of values for Tb may be obtained for a particular nylon. In the context of the present invention, however, Tb indicates the highest possible Brill temperature, which is the Brill temperature for perfect or near perfect crystalline nylon. The reported Brill temperatures are therefore measured on crystals grown from good solvents under ideal conditions, such that the highest possible Brill temperatures are obtained. The Brill temperature ranges from 90 to 250° C., and is usually lower than the melting temperature of the polyamide. In the process of the invention temperatures can be applied that differ from the Brill transition temperatures due to the non-ideal situation that may be present. The temperature of the present invention ranges between 120° C. below the Brill temperature to 50° C. above this temperature for a given polyamide. Preferably the temperature ranges between 100° C. below and 10° C. above the Brill temperature, more preferably between 80° C. below and 10° C. below the Brill temperature.

TABLE 2
Brill temperatures of even (X)-even(Y) polyamids
(from Macromolecules 2000, 33, 2642-2650).

X

| Y | 2 | 4 | 6 | 8 | 10 | 12 |
|---|---|---|---|---|---|---|
| 4 | 240 | 170 | 190 | 190 | 160 | 180 |
| 6 | 174 | 245 | 230 | 194 | 184 | 183 |
| 8 | 177 | 250 | 203 | 213 | 222 | 213 |
| 10 | 181 | 240 | 220 | 185 | 200 | 188 |
| 12 | 158 | 235 | 215 | 202 | 193 | 181 |
| 18 | | | 190 | | | |

It may sometimes be difficult to determine the Brill transition temperature, or for some polyamides the Brill transition temperature may not exist. In that case, the mixture comprising polyamide, water and salt is heated to a temperature between 150 and 10° C. below the melting temperature of the polyamide, or preferably between 140 and 30° C., more preferably between 130 and 50° C. below the melting temperature of the polyamide. In case a polyamide does not have a melting temperature, the mixture comprising polyamide, water and salt is heated to a temperature between 150 and 10° C. below the degradation temperature of the polyamide, or preferably between 140 and 30° C., more preferably between 130 and 50° C. below the degradation temperature of the polyamide.

The surprisingly low Brill and melting temperatures of the polyamides in the water/salt mixtures allows to design a simple process, wherein the application of said process reduces the amount of energy needed to dissolve the polyamide, side effects like hydrolysis of the polyamides or thermal degradation are reduced, and speed of the process can be enhanced. The low Brill and melting temperatures also allow to design for example an environmental friendly gel spinning process to make ultra strong nylon fibers.

The amount of water preferably ranges between 20 and 95 wt % (relative to the total of the composition). The amount of water present in the process of the invention is higher than the amount of water that may be present in the polyamide as such, due to its hygroscopic nature. It is known that a polyamide generally may comprise a few wt % of water. More preferably the amount of water ranges between 30 and 90 wt %, or even more preferably between 40 and 80wt % of the total composition.

The process of the present invention applies a salt to suppress the formation of crystals or to lower the crystallization temperature of the polyamide and also to lower the dissolution temperature of the polyamide, as indicated before. It is possible to use a single salt, or also mixtures of salts can be used.

The salt preferably is an alkali metal salt. Preferably the salt contains an anion that is weakly hydrated according to the Hoffmeister series of ions. Examples of such weakly hydrated anions are Cl⁻, Br⁻, I⁻, NO₃⁻, ClO₃⁻, BrO₃⁻, IO₃⁻ or ClO₄⁻. Preferred anions are selected from the group consisting of Br⁻, I⁻, NO₃⁻, ClO₃⁻, BrO₃⁻ or ClO₄⁻. Most preferred anions are Br⁻I⁻, ClO₃ or ClO₄. Preferably the salt contains a cation that is strongly hydrated (according to the Hoffmeister series of ions). Examples of cations that are strongly hydrated are K⁺, Na⁺, Li⁺, Zn²⁺, Ca²⁺, Mg²⁺, Al³⁺ and Ga³⁺. Preferred cations are Na⁺, Li⁺, Zn²⁺, Ca²⁺, Mg²⁺, because of the high solubility of these cations when present in aqueous solutions. Most preferred cations are Na⁺, Li⁺, Ca²⁺.

Most preferably, the salt is selected from the group consisting of LiBr, LiI, NaBr and NaI.

The concentration of the salt that may be used in the process of the present invention may be determined by the depression of the melting point of the polyamide that is desired to be obtained or alternatively by the lowering of the dissolution temperature of the polyamide that is desired. In one embodiment of the invention a polyamide can be obtained that has no crystallinity and acts like a gel in water or as an aqueous solution. In another embodiment of the invention, the polymer is present as a suspension and has a reduced melting point between for example −50° C. and for example 150° C., preferably a melting point between 20 and 120° C. or between 30 and 100° C.

The ratio of salt to polyamide, required to obtain complete suppression of crystallization at 30° C., ranges between 0.1 and 3 mol salt relative to the mols of amide bonds present in the polymer. Preferably the ratio is between 0.2 and 1.5, more preferably between 0.25 and 1.0, most preferably between 0.3 and 0.9. The effectivity of the suppression of the crystallization temperature also depends on the polymer concentration in water. When low polymer concentrations are applied (for example 10 wt % polymer), the molar ratio salt/amide units is preferably between 2 and 3, while at very high polymer concentrations like for example 60 wt %, the molar ratio salt/amide units ranges between 0.2 and 0.5 in order to obtain complete suppression of crystallinity. In general, for complete suppression of crystallinity the following relation can be used:

Solubilization Area (SA)=Polymer concentration (wt %)×molar ratio (salt/amide units)

, which ranges between 10 and 40, preferably between 15 and 30.

In one embodiment of the invention, the polyamide is dissolved in water containing between 3 and 20 mol/liter of salt, preferably between 4 and 15 mol/l, more preferably between 5 and 10 mol/l.

The polyamides typically dissolve at a temperature below the Brill transition temperature when salts are present. In general the reduction of dissolution temperature increases when higher concentrations of salt are present. The reduction of the dissolution temperature can be calculated as the Tb—Td (Tb is the Brill transition temperature and Td is the dissolution temperature). The ratio of [Tb—Td]/salt concentration (mol/l) ranges between 3 and 10, preferably between 4 and 8.

These amounts of salts used to suppress crystallinity are unexpectedly low compared to other literature data. In the cited literature equimolar amounts of salts to amide moieties are needed to fully suppress crystallinity. In the process of the present invention lower amounts of salts can be efficiently used to obtain the same or higher reduction in crystallinity. This can give all kinds of advantages like for example an easier and cheaper process, and less recovery of salts from the polyamide in subsequent process steps.

The product of the process of the present invention is a composition comprising 1-95 wt % polyamide with a viscosity average molecular weight between 10⁴ g/mol and 10⁹ g/mol, 20-95 wt % water and a salt. The polyamide preferably have a melting point between −50° C. and 150° C. The product of the invention may be present as a gel or as an aqueous solution. This unique composition can have very interesting properties and applications depending on the ratio of the different components. The gel or aqueous solution can be used in for example a gel spinning process. Gel spinning processes are known to the skilled man. The gel can also be used as an amorphous polyamide, as a coating composition, for example by adding the composition to a substrate and washing away or exchanging the specific salt with water to restore crystallinity again of the polyamide and form a layer of polyamide on the substrate.

The aqueous solution can also be used to make oriented polyamide filaments. This can for example be done, by taking the aqueous solution containing polyamide, water and salt, applying this to a substrate, applying an extensional deformation by for example shearing/deforming the solution with a razor blade or doctor's blade, rinsing the extensionally deformed solution with water, thereby allowing the polyamide to crystallize as oriented filaments. These filaments can have a Hermans orientation factor of above 0.8, for example above 0.9 or even above 0.96.

A way to determine and calculate the orientation factor is described by A. V. Tokarev et al. (Orientation of high-modulus polyamide fibers, Mech of Comp. Mat, vol 23, no 5., September 1988 (1988-09), pgs 529-533)

The invention is illustrated by means of examples, which are not intended to limit the scope of the invention and with reference to the appended Figures:

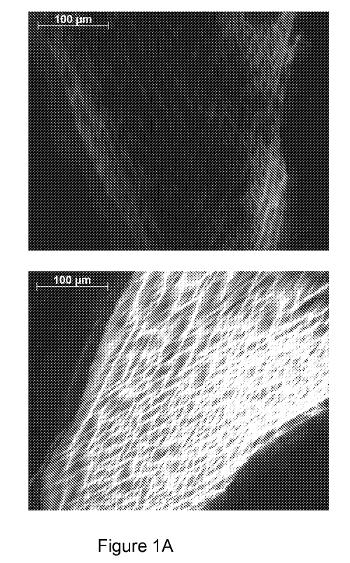

FIG. 1 shows an optical micrographs (A) of oriented polyamide 4,6 crystals obtained after crystallization of the extensionally deformed aqueous gel by rinsing with water. In between crossed polars the change in birefringence by a sample rotation of 45° to the polarized light indicates the presence of orientation. Based on normalization of the crystalline CH₂ scissoring band at 1417 cm⁻¹ in the dichroic measurements on PA 4,6 filaments (B), the Hermans orientation factor can be determined and appears to be 0.9.

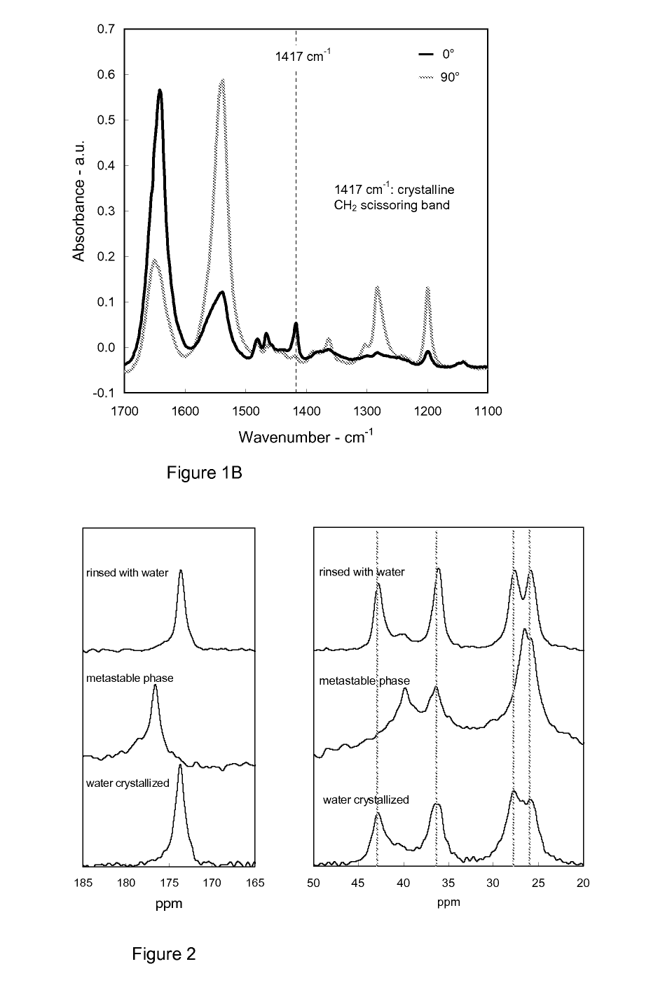

FIG. 2 shows the result of a solid state ¹³C NMR on polyamide 4,6 from superheated water solely as a reference (water crystallized) and on the metastable phase before and after rinsing with water. The metastable phase shows typical amorphous chemical shifts for the carbonyl (176.5 ppm) and the α and β methylene groups in the diamide segments (39.6 ppm and 26.4 ppm respectively) that all return to their typical crystalline chemical shifts after washing with water.

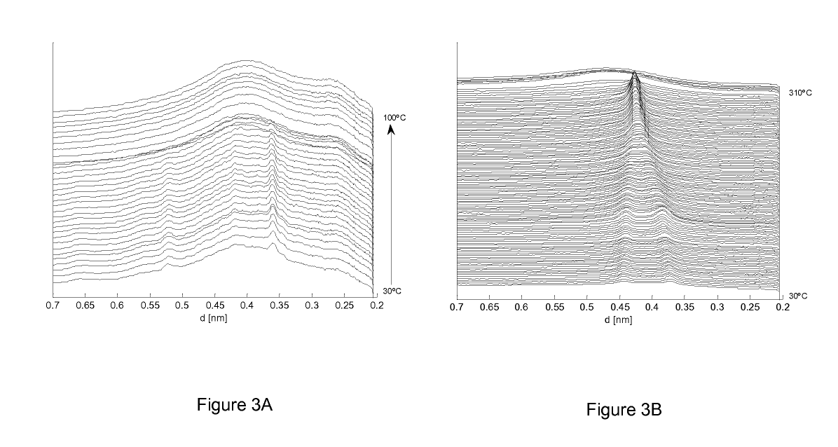

FIG. 3 shows wide angle X-ray diffraction patterns of A) polyamide 4,6 with insufficient ions to suppress crystallization at room temperature, forming a metastable structure that melts at 80° C. and B) the same polyamide 4,6 sample after removal of ions by immersion in water. The d-spacings show typical temperature dependent trends as observed in semi-crystalline polyamide 4,6 obtained from melt or solution.

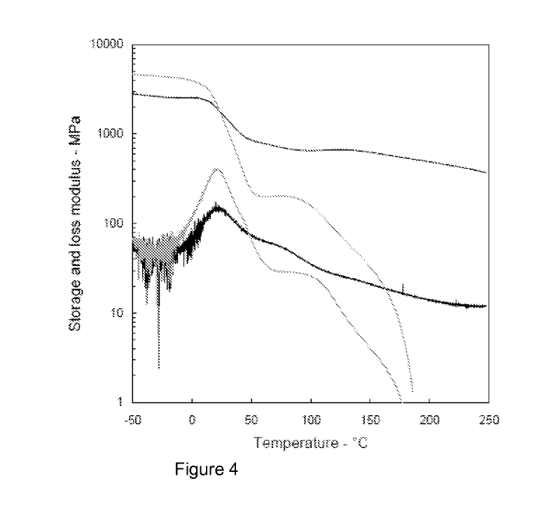

FIG. 4 shows the storage modulus (upper lines) and loss modulus (bottom lines) as function of temperature for semicrystalline PA46sc (black) and amorphous PA46LiI samples (grey).

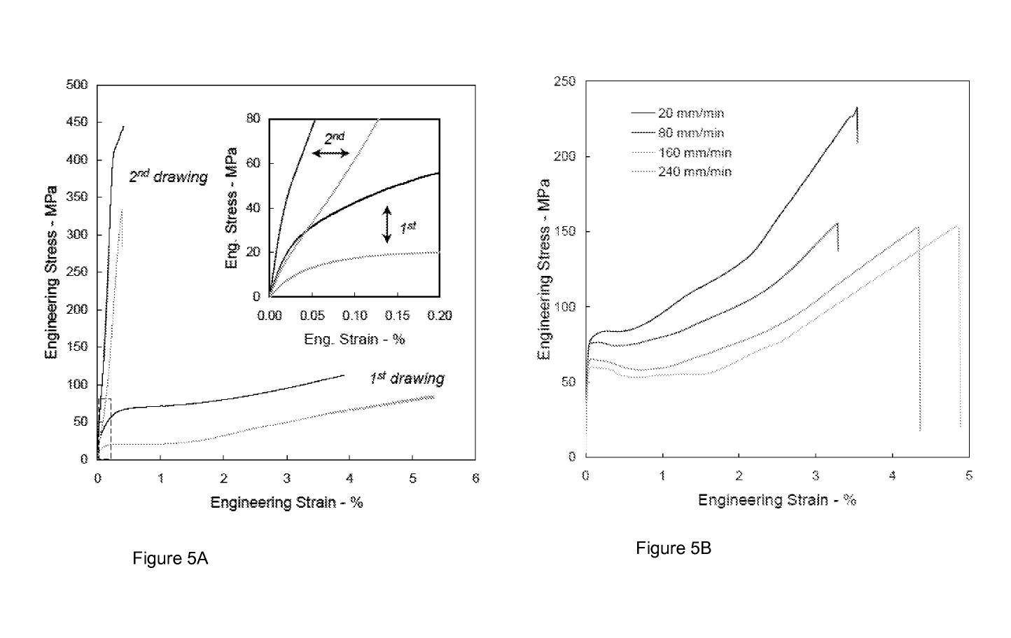

FIG. 5 Shows (A) Stress-strain curves of the semicrystalline PA46sc (black) and amorphous PA64LiI (grey) samples in two successive tensile tests; and (B) influence of deformation rate on the stress-strain diagrams.

### EXAMPLE 1

In a closed reactor, 40 w/w-% Polyamide 4,6 is immersed in an 9M (M=mol/l) aqueous LiBr solution and heated from room temperature to 220° C. at a rate of 50° C./min using linkam TMS93 control unit. Since the evaporation of water is inhibited, the water vapor pressure at 220° C. reaches approximately 20 bar. The dissolution temperature of the polyamide 4,6 is 137° C., which is 158° C. below the melting temperature and 108° C. below the Brill transition. After an isothermal period of 3 minutes the solution is cooled by flushing the reactor with compressed air. At room temperature the ions shield the hydrogen bonding effectively, meaning that crystallization is suppressed completely. The gel/ solution obtained, is transferred to a zinc selenium disk and exposed to extensional deformation using a razor blade. Immediately after deformation of the gel, where hydrogen bonding is shielded, the gel was rinsed with water to remove the ions to form oriented polyamide 4,6 crystals. The oriented structures were characterized by Optical Microscopy and Dichroic Measurements using polarized FTIR (FIGS. 1A and 1B). Oriented Polyamide 6 and 6,6 structures are obtained analogously using LiI to shield the hydrogen bonding between the amide moieties.

### EXAMPLE 2

In a closed reactor, 40 w/w-% Polyamide 4,6 is immersed in an 7M aqueous LiBr solution and heated from room temperature to 220° C. at a rate of 50° C./min using linkam TMS93 control unit. Since the evaporation of water is inhibited, the water vapor pressure at 220° C. reaches approximately 20 bar. The dissolution temperature of the polyamide 4,6 is 158° C., which is 137° C. below the melting temperature and 87° C. below the Brill transition. After an isothermal period of 3 minutes the solution is cooled by flushing the reactor with compressed air. At room temperature insufficient ions are present to shield the hydrogen bonding effectively, resulting in a metastable phase in water with a reduced melting point between room temperature and the dissolution temperature. The reversible nature of the present invention is depicted by solid state ¹³C measurements on the metastable crystals before and after rinsing with water to remove the shielding ions (FIG. 2). The metastable phase shows typical amorphous chemical shifts for the carbonyl and the α and β methylene groups in the diamine segments. It has to be noted that in symmetric polyamides the chemical shifts for α and β methylene segments in the diacid segment are similar in the amorphous and crystalline state. Also from a crystallographic point of view the reversible concept is proven. In FIG. 3A the diffraction pattern of the metastable phase, which contains a broad amorphous component, melts at about 80° C. on heating with 10° C./min. After washing the same sample with water, in analogy to the ¹³C NMR experiment, the typical merging of the intersheet and interchain reflections (The Brill Transition) in polyamide 4,6 and the melting at 295° C. are observed in FIG. 3B.

### EXAMPLE 3

Using differential scanning calorimetry (DSC) the dissolution and precipitation of commercial polyamide (PA) 46 (Stanyl®, DSM), 6 (Ultramid® B, BASF) and 66 (Ultramid® A, BASF) (10 to 60%-w/w) in superheated water, whether or not in the presence of ions, was monitored in Perkin Elmer high volume DSC pans under a nitrogen atmosphere. The cryo-ground polymeric samples were immersed in the aqueous solutions and exposed to a temperature program ranging between 30° C. and 240° C. at a rate of 10° C./min. To ensure an equilibrium state, an isothermal period of 3 minutes was applied at the temperature limits. Since the evaporation of water is inhibited, the sealed environment facilitates the superheated conditions automatically. Based on the Hofmeister series solubilizing salts were selected comprising the kosmotropic cation Li⁺ and chaotropic anions Br⁻ and I⁻. Stock solutions were prepared with ionic strengths ranging between 0 mol/l and 10 mol/l.

Results of the DSC experiments can be found in tables 3.1-3.6, where dissolution and crystallisation temperatures are listed of the different polyamide/water/salt systems that have been examined.

TABLE 3.1
Dissolution temperatures of PA46 in LiBr-solutions

| Molarity | Wt % polyamide 46 in the mixture | | | | | |
|---|---|---|---|---|---|---|
| LiBr in | 10 | 20 | 30 | 40 | | |
| water | w/w-% | w/w-% | w/w-% | w/w-% | 50 w/w-% | 60 w/w-% |
| mol/l | ° C. | ° C. | ° C. | ° C. | ° C. | ° C. |
| 1 | 176.0 | 177.8 | 177.8 | 176.0 | 175.6 | 180.0 |
| 2 | 174.8 | 173.8 | 175.8 | 177.6 | 175.6 | 179.2 |
| 3 | 175.7 | 172.1 | 172.5 | 173.3 | 173.8 | 175.5 |
| 4 | 174.1 | 176.4 | 170.3 | 171.6 | 173.0 | 171.3 |
| 5 | 170.0 | 169.6 | 167.3 | 167.8 | 168.6 | 170.1 |
| 6 | 160.6 | 164.4 | 165.4 | 167.1 | 163.9 | 165.3 |
| 7 | 152.8 | 154.5 | 159.4 | 157.5 | 159.1 | 162.4 |
| 8 | — | — | 148.8 | 153.4 | 156.7 | 156.7 |

TABLE 3.2
Crystallization temperature of PA46 in LiBr-solutions

| Molarity | Wt % polyamide 46 in the mixture | | | | | |
|---|---|---|---|---|---|---|
| LiBr in | 10 | 20 | 30 | 40 | | |
| water | w/w-% | w/w-% | w/w-% | w/w-% | 50 w/w-% | 60 w/w-% |
| mol/l | ° C. | ° C. | ° C. | ° C. | ° C. | ° C. |
| 1 | 138.1 | 144.7 | 140.7 | 140.0 | 138.2 | 145.5 |
| 2 | 132.1 | 136.0 | 137.8 | 137.7 | 138.5 | 144.5 |
| 3 | 129.5 | 130.3 | 130.7 | 134.0 | 135.0 | 137.3 |
| 4 | 119.8 | 122.8 | 123.3 | 128.1 | 131.3 | 137.8 |
| 5 | 109.4 | 110.1 | 119.8 | 118.4 | 122.9 | 129.8 |
| 6 | Nc | 101.0 | 113.4 | 107.6 | 112.2 | 120.4 |
| 7 | Nc | nc | 76.2 | 88.0 | 101.2 | 114.7 |
| 8 | Nc | nc | nc | nc | 90.8 | 107.7 |

Nc: no crystallization observed at 30° C.

TABLE 3.3
Dissolution temperatures of PA66 in Lil-solutions

| Molarity | Wt % polyamide 66 in the mixture | | | |
|---|---|---|---|---|
| Lil in | 30 w/w- | 40 w/w- | 50 w/w- | 60 w/w- |
| water | % | % | % | % |
| mol/l | ° C. | ° C. | ° C. | ° C. |
| 1 | 176.1 | 178.2 | 176.5 | 177.5 |
| 2 | 173.5 | 173.8 | 175.3 | 175.8 |
| 3 | 169.2 | 168.5 | 169.3 | 170.2 |
| 4 | 160.1 | 163.3 | 163.8 | 167.3 |
| 5 | 152.1 | 154.7 | 156.6 | 156.3 |
| 6 | 141.7 | 145.7 | 148.4 | 150.6 |

TABLE 3.4
Crystallization temperature of PA66 in Lil-solutions

| Molarity | Wt % polyamide 66 in the mixture | | | |
|---|---|---|---|---|
| Lil in | 30 w/w- | 40 w/w- | 50 w/w- | 60 w/w- |
| water | % | % | % | % |
| mol/l | ° C. | ° C. | ° C. | ° C. |
| 1 | 143.9 | 143.7 | 143.4 | 143.3 |
| 2 | 135.7 | 136.0 | 139.0 | 139.5 |
| 3 | 125.1 | 126.0 | 128.8 | 132.8 |
| 4 | 108.7 | 116.0 | 119.4 | 122.5 |
| 5 | Nc | 102.7 | 104.0 | 112.4 |
| 6 | Nc | nc | 88.3 | 96.0 |

TABLE 3.5
Dissolution temperatures of PA6 in Lil-solutions

| Molarity | Wt % polyamide 6 in the mixture | | | |
|---|---|---|---|---|
| Lil in | 30 w/w- | 40 w/w- | 50 w/w- | 60 w/w- |
| water | % | % | % | % |
| mol/l | ° C. | ° C. | ° C. | ° C. |
| 1 | 153.9 | 154.2 | 153.7 | 153.6 |
| 2 | 149.2 | 150.0 | 151.9 | 150.0 |
| 3 | 138.6 | 143.2 | 143.0 | 144.5 |
| 4 | 136.3 | 136.8 | 138.0 | 138.1 |
| 5 | 124.5 | 120.5 | 125.5 | 124.7 |
| 6 | 111.3 | 114.0 | 116.8 | 120.5 |

TABLE 3.6
Crystallization temperature of PA6 in Lil-solutions

| Molarity | Wt % polyamide 6 in the mixture | | | |
|---|---|---|---|---|
| Lil in | 30 w/w- | 40 w/w- | 50 w/w- | 60 w/w- |
| water | % | % | % | % |
| mol/l | ° C. | ° C. | ° C. | ° C. |
| 1 | 111.1 | 112.9 | 113.1 | 111.7 |
| 2 | 99.7 | 101.9 | 104.2 | 103 |
| 3 | 88.2 | 90.8 | 91.5 | 95.7 |
| 4 | Nc | 81.2 | 82.7 | 87.5 |
| 5 | Nc | nc | 69.8 | 72.5 |
| 6 | Nc | nc | nc | 58.2 |

### EXAMPLE 4

Commercial polyamide 46 (Stanyl® KS300) and lithium iodide beads (99%) were supplied by DSM and Aldrich respectively. A premix of 84% w/w PA46 and 16% w/w 9M LiI solution was prepared and fed to an Haake Rheomex OS PTVV 16 co-rotating twin screw extruder. Feeding was torque controlled at 80% of the maximum, 130 Nm, at a screw speed of 100 rpm. The temperature profile ranged from 325° C. in the first zone to 240° C. in the last zone, resulting in an extrudate temperature of 240° C. at the die. It has to be noted that dissolution in the superheated state of water and the presence of Li⁺ and I⁻ ions facilitate extrusion at temperatures well below conventional PA46 processing temperatures. The transparent extrudate was collected carefully to minimize pre-orientation induced by the extrusion process. As a reference polyamide 46 extrudates were prepared identically resulting in semicrystalline samples (PA46sc). However, the temperature zones were set from 325° C. in the first zone to 300° C. in the last zone, resulting in an extrudate temperature of 310° C. at the die. Samples from the LiI (PA46LiI) and the melt route (PA46sc) were drawn successively by hand in air and water at 20, 55 and 95° C.

### Test Methods of the Drawn Samples

The PA46 extrudates obtained from the melt and LiI route were measured at on a TA DMA Q800 with a tension setup. A temperature sweep from −50 to 350° C. was applied with a heating rate of 3° C./min at a frequency of 1 Hz. A preload force of 0.01 N, an amplitude of 10 |im and a force track of 110% were used.

### Tensile Testing

The drawing behavior of PA46sc and PA46-LiI extrudates, being less than 0.5 mm diameter, was monitored at 5 mm/min using a ZwickZ100 tensile tester equipped with a 100 N load cell and 0.1 N preload. As the initially transparent PA46LiI filaments became white on tensile deformation, suggesting strain induced crystallization, the influence of drawing was evaluated by a second, identical tensile test immediately after breakage of the samples. The influence of draw rate was furthermore monitored on a Textechno Favimat tensile tester using draw rates ranging between 20 and 240 mm/min. As a reference, strain induced crystallization and molecular orientation of the PA46 melt extrudate as function of draw ratio A was besides investigated by preparing samples of different draw ratios.

The influence of drawing media, either air or water, and temperatures on the eventual mechanical performance was investigated by testing the extensively dried samples (30° C. under vacuum) at 2 mm/min using a Instron 5564 tensile tester equipped with a 2 kN load cell and pneumatic action grips.

### Differential Scanning Calorimetry

Crystalline structure development on drawing, whether or not with efficient removal of ions, was investigated by exposing the samples to two successive temperature profiles, ranging from 5 to 325° C. at a rate of 10° C./min and 3 minutes of isothermal conditions at the temperature limits. The experiments were performed on a TA Q1000 DSC apparatus under nitrogen atmosphere. Crystallinity X_{C} was determined by the quotient of the measured heat of fusion in the first temperature cycle ΔHₑₓₚ, and 210 J/g, the heat of fusion of a 100% crystalline PA46 ΔH₁₀₀% (Polymer Handbook 4^{th} ed, Wiley, New York, 1999), according to the following equation:

$${X}_{C} = \frac{Δ {H}_{exp .}}{Δ {H}_{100 \%}} \cdot 100 \%$$

### Solid State ⁷Li Nuclear Magnetic Resonance Spectroscopy

Solid state ⁷Li MAS NMR spectroscopy was used to probe the dissociation of the LiI salt in the PA46LiI extrudates using a Bruker 500 MHz spectrometer (11.75 T) at the Max Planck Institute for Polymer Science (MPIP) in Mainz, Germany. ⁷Li NMR spectra of PA46LiI sample (the as extruded), LiBr and LiI were recorded at ambient temperature employing a 2.5 mm probe, a spinning speed of 25.0 kHz and ¹H decoupling during acquisition.

### Polarized Infrared Spectroscopy

Orientation of the drawn samples was studied by dichroic measurements using polarized FTIR. The polarized FTIR spectra of 20 μm thick slices were recorded either parallel or perpendicular to the orientation direction using a Bio-Rad FTS6000 spectrometer equipped with a microscope and a resolution of 2 cm⁻¹. Normalization of the crystalline CH₂ scissoring band at 1417 cm⁻¹ under the two polarization directions enables the determination of the dichroic ratio:

D=A_{II}/A_{⊥}

Wherein A is the maximum absorption in parallel II or perpendicular ⊥ orientation direction, and the Herman's orientation factor f by

<P₂(cos θ)>=f=[(D−1)/(D+2)]÷½(3 cos² β−1)

Wherein β is the molecular transition-moment angle. For the crystalline CH₂ scissoring band at 1414 CM⁻¹ a transition moment angle of 85° was used (Cole et al., Pol. Eng. Sci, 2004, 44, 21-240).

FIG. 4 addresses the storage and loss modulus as a function of temperature for the semicrystalline PAsc (comparative) and the PA46LiI (from solution example) samples. It is evident that below the glass transition temperature, which for both samples is 21° C., the storage modulus of the PA46LiI sample is higher than the storage modulus for the semicrystalline PA46 sample, 4.3 and 2.5 GPa respectively. The difference in storage modulus suggests different characteristic ratios (chain stiffness) for the two samples. The high storage modulus for PA46LiI suggests higher chain stiffness due to the interaction of ions with the polyamide molecules (Richardson et al., J. Polym. Sci., Polym., Phys. Edn., 1981, 19, 1549-1565 and Science, 288, 448-449), supporting the conclusions of chapter 5. Due to the presence of crystals in the semi-crystalline PA46sc sample some stiffness is retained above the glass transition temperature, featuring a storage modulus of 0.66 GPa. Whereas, the storage modulus of the PA46LiI sample reaches the rubber plateau (0.20 GPa) and upon further heating the material flows at 106° C. These results conclusively demonstrate that the presence of lithium and iodide ions suppresses crystallization of polyamide 46.

Drawability of the semicrystalline and amorphous PA46 samples was monitored under tensile deformation. FIG. 5A shows the engineering stress-strain curves of the two successive tensile deformations. The very first striking difference in the initial tensile experiments between the PA46sc and PA46LiI sample is the yield stress, being 58 and 20 MPa respectively. The low yield stress of the PA46LiI sample arises due to the absence of crystalline domains that are known to contribute more to the yield stress than the amorphous component (Schrauwen et al., Macromolecules, 2004, 37, 6069). The elasticity modulus E is 1.3 and 0.45 GPa for the semicrystalline and amorphous PA46 respectively. At large strain deformation strain hardening is observed in both samples. Since polyamides are generally of relatively low molecular weight, reducing the number of entanglements, strain hardening cannot be explained by trapped chain entanglements acting as physical constrains/cross-links (Persyn et al., Polym. Eng. Sci. 2004, 44, 21-271). Instead, strain induced crystallization and whitening of the initially transparent PA46LiI sample, is likely to result in tie molecules bridging the crystallites that effectively contribute to the network. It can be stated that tensile deformation of the amorphous PA46LiI sample requires less stress compared to the semicrystalline PA46sc sample. In the second tensile experiment performed on the samples drawn in the first tensile experiment, the effect of strain induced crystallization is clearly demonstrated. Not only do the elastic moduli of the PA46sc and PA46LiI samples increase significantly, 2.6 and 1.1 GPa respectively, but also the yield stress increases from 112 and 84.8 MPa to 445 and 333 MPa respectively.

The influence of deformation rate on the engineering stress-strain curves of the amorphous polyamide samples is shown in FIG. 5B. Upon increasing deformation rates the yield stress of the PA46LiI samples decreases significantly. Since the yield stress is governed by the crystalline fractions, fast deformation appears to result in suppression of the strain induced crystallization. The sample drawn at 20 mm/min, shows the highest yield stress suggesting the highest crystallinity in the investigated samples, hardly shows strain softening and the progression of crystallization is depicted by strain hardening at relatively small strain deformation. Fast drawing, especially in the samples tested at 160 and 240 mm/min, results in a relatively low yield stress, where the suppression of crystallization induces a high degree of strain softening. In fact, the respective samples neck considerably until strain hardening occurs at larger deformation rates. At high deformation rates however, strain induced crystallization is postponed.

TABLE 4
The effect of drawing conditions on hydrogen bonding, orientation
and melting characteristics

| drawing | | | | Melting | | |
|---|---|---|---|---|---|---|
| environment | | H-bonding | orientation | characteristics | | |
| medium | temperature | amide II | f | Tₘ^{a)} | ΔHₘ^{a)} | X_{C}^{a)} |
| — | ° C. | — | — | ° C. | J/g | % |
| air | 20 | 1544.3 | 0.97 | 228 | 17.6 | 8.40 |
| air | 55 | 1544.5 | 0.80 | 229 | 18.4 | 8.78 |
| air | 95 | 1543.7 | 0.90 | 229 | 21.1 | 10.1 |
| H₂O | 20 | 1543.7 | 0.94 | 244 | 31.0 | 14.8 |
| H₂O | 55 | 1542.0 | 0.98 | 247 | 38.6 | 18.4 |
| H₂O | 95 | 1542.7 | 0.93 | 251 | 45.7 | 21.8 |
| H₂O | 55/5 | 1542.1 | 0.99 | 270 | 63.5 | 30.2 |
| H₂O | 95/5 | 1542.4 | 0.91 | 269 | 63.0 | 30.0 |

^{a)}Where Tₘ is the Melting temperature, ΔHₘ the heat of fusion and X_{C} crystallinity.

1. A process for making a mixture comprising a polyamide, water and a salt, comprising the steps of:
a. mixing the polyamide, water and a salt;
b. heating the mixture to a temperature above 100° C. and in a range between 120° C. below the Brill temperature and 50° C. above the Brill temperature of the polyamide at a pressure above the vapour pressure of the mixture at said temperature; and
c. optionally cooling down the mixture,
wherein the mixture comprises 1-95 wt % polyamide and 20-95 wt % water, both relative to the total composition and wherein the polyamide has a viscosity average molecular weight between 10⁴ g/mol and 10⁹ g/mol.

2. A process for making a mixture comprising a polyamide, water and a salt, comprising the steps of:
a. mixing the polyamide, water and a salt;
b. heating the mixture to a temperature above 100° C. in a range between 150° C. and 10 ° C. below the melting temperature of the polyamide at a pressure above the vapour pressure of the mixture at said temperature; and
c. optionally cooling down the mixture,
wherein the mixture comprises 1-95 wt % polyamide and 20-95 wt % water, both relative to the total composition and wherein the polyamide has a viscosity average molecular weight between 10⁴ g/mol and 10⁹ g/mol.

3. The process according to claim 1, wherein the polyamide is present in an amount between 5 and 60 wt %.

4. The process according to claim 1, wherein the amount of water ranges between 40-80 wt %.

5. The process according to claim 1, wherein the salt is an alkali metal salt.

6. The process according to claim 1, wherein the salt comprises an anion from the group consisting of Br⁻I⁻, ClO³⁻ or ClO₄⁻.

7. The process according to claim 1, wherein the salt comprises cations selected from the group consisting of Na⁺, Li⁺, Ca²⁺.

8. The process according to claim 1, wherein the salt is chosen from the group consisting of LiBr, LiI, NaBr, and NaI.

9. The process according to claim 1, wherein the concentration of salt in water ranges between 3 and 20 mol/l salt.

10. A composition containing 1-95 wt % polyamide having a viscosity average molecular weight between 10⁴ g/mol to about 10⁹ g/mol, between 20 and 95 wt % water and a salt, the composition being a gel or an aqueous solution.

11. The composition according to claim 11, wherein the polyamide is chosen from the group consisting of polyamide 6, polyamide 11, polyamide 12, polyamide 4,6, polyamide 6,6, polyamide 6,9, polyamide 6,10, polyamide 6,12.

12. The composition according to claim 10, wherein the polyamide has a melting point between −50° C. and 150° C.

13. The composition according to claim 10, wherein the salt is present in a concentration between 3 and 20 mol/l in water.

14. Use of the composition according to claim 10 for making fibers of polyamide.

15. Oriented polyamide fibers having a Hermans orientation factor of at least 0.96.
